(19) United States
(12) Patent Application Publication
(10) Pub. No.: US 2017/0368713 A1
(43) Pub. Date: Dec. 28, 2017

(54) DEVICE AND METHOD FOR PRODUCING COMPONENTS FROM CONCRETE AND CONCRETE COMPONENTS PRODUCED BY MEANS THEREOF

(71) Applicant: KENNWERT RD GMBH, Kassel (DE)

(72) Inventors: Thorsten KLOOSTER, Berlin (DE); Jan JURASCHEK, Kassel (DE)

(73) Assignee: KENNWERT RD GMBH, Kassel (DE)

(21) Appl. No.: 15/544,467

(22) PCT Filed: Jan. 19, 2016
(86) PCT No.: PCT/EP2016/051032

§ 371 Date: Jul. 18, 2017

(30) Foreign Application Priority Data
Jan. 19, 2015 (DE) 10 2015 100 715.0

(51) Int. Cl. B28B 19/00; E04G 9/10; B28B 23/00; E04G 17/00; B28B 13/02

(52) U.S. Cl. CPC B28B 19/0053; E04G 17/00; B28B 13/021; B28B 23/0056; E04G 9/10

(57) ABSTRACT

The invention relates to a formwork element for a formwork system for concrete building purposes, in particular for integration into a construction plane of the formwork system, having a box-like supporting body (1, 2) facing away from the concrete, having an upper side (6) facing the concrete in use, having a recess (3) in the upper side (6) for the fastening of concrete-facing forming means (11; 11′; 35) which can be fastened on/in the recess (3), having a vacuum-permeable spacer (14; 17) having a plurality of passage openings (16), and having connection devices (7, 8, 9) for applying a vacuum, wherein a plurality of forming means (35) can be reversibly fastened by means of vacuum at the top side (6). The invention also relates to a formwork system having such a formwork element and a concrete component which has been created with the formwork element or the formwork system.

The invention relates to a formwork element for a formwork system for concrete construction purposes for integration into a construction plane of the formwork system, by means of which a surface of a concrete component to be produced can be designed in a targeted manner. The invention also relates to a formwork system for concrete construction purposes having a number of formwork elements which can be coupled to one another for configuring a concrete formwork structure for receiving fresh concrete. Furthermore, the invention relates to a method for producing a concrete component with such a formwork system, and concrete components which were produced according to this method and by using the formwork system.

The object of the invention is to specify a formwork element or a formwork system or a method for producing a concrete component by means of a formwork system with which the surface of a concrete component can be designed in a targeted manner, and components produced by it.

This object is achieved by a formwork element for concrete construction purposes, in particular for integration into the construction plane of a formwork system, which is designed with a box-like, supporting body facing away from the concrete, having an upper side concrete-facing in use, having at least one concrete-facing forming means that can be fastened on or in the recess and having connection devices for applying an vacuum such that different forming means can be reversibly fastened as a formwork shell of the formwork element on the surface by means of vacuum. The formwork element is suitable for both in-situ concrete and ready-made concrete parts. It comprises a spacious, e.g., cubic, usually flat, box-like supporting body, for example, having a rear wall extending parallel to the construction plane and facing away from the concrete in use, end walls as edge boundaries running orthogonally to it. First, the supporting body is used to support a formwork shell, namely the forming means described later; second, possibly, to fasten the formwork element, for example, in a shell system; and third, to form on the side of the surface facing away from the concrete, with side walls, an interior space or cavity filling the supporting body to a large extent. As sidewalls, the supporting body can comprise a rear wall facing away from the concrete which, as a rule, extends largely parallel to the construction plane in the case of a cubic supporting body. Further side walls form the narrow front walls which run orthogonal to the rear wall in the case of a cubic supporting body and which, because of the possibility of configuring the supporting body very flat, can be used as mechanical connection surfaces or as interfaces of the formwork element for a formwork system. In a conventional formwork system for concrete walls, in a so-called system formwork, the formwork element according to the invention lies against other formwork elements with largely similar end walls and is, as a rule, mechanically connected thereto. In any case, the end walls surround or define, in the case of a planar formwork element, an upper side of the supporting body, which lies largely in an extension plane of the formwork element and, in use, faces the future concrete component. The upper side of the supporting body is, in this respect, to be understood as a geometrical location, the extent of which is defined by the end walls, which surround it in a frame-like manner. The design of the future concrete component from the surface of the formwork element is not limited only to an optical or designer molding or structuring but can also include a functionalization of the concrete surface. For this purpose, the concrete component may be supplemented by a number of objects, which may also contain foreign material, such as glass beads, sensors or microelectronic components.

According to the invention, at least one recess is provided in the upper side of the supporting body, the recess being able to partly or completely cover or take in the upper side. The recess projects into the supporting body and thus into the interior space thereof and can fill it completely at maximum. It opens into it or has connection devices for applying an externally generated vacuum, which in any case, acts in the recess. The recess thus represents a vacuum chamber. The connecting devices can basically be attached to an arbitrary side wall of the supporting body. In the case of a cubic supporting body, this can advantageously be the rear wall because then the side walls can be available for coupling with other formwork elements.

According to the invention, the recess or the vacuum chamber is used to fasten forming means to the upper side of the supporting body. The forming means allow a surface of a future concrete component facing the formwork element to be designed. The design which the forming means supply can consist of only a superficial influence or structuring or of a spatial configuration of the concrete component of its surface facing the formwork element. For this purpose, the forming means can be used as a conventional formwork shell, as a lost formwork, or as a combination of a formwork shell with sections of a lost formwork. They can either be inserted into the recess as rigid bodies or as flexible foil-like or die-like elements, or they stretch over so that they are reversibly fastened in any case to the concrete-facing surface of the supporting body. The forming means can, for example, be a stiffened plate on the upper side, a flexible die or a number of elements which remain as a lost formwork in the finished concrete component. A combination of these is also possible. The forming means can cover the recess over the surface fully or only partially. Forming means may also be those agents which, instead of or in addition to a shaping effect, effect a functionalization of the concrete component. In any case, the forming means represent those components of the formwork element which are held by the vacuum on the supporting body, even if further components of the formwork element can also contribute to the shaping. After switching off the vacuum, the forming means which are not used as a lost formwork can consequently be removed and exchanged for similar or other forming means for a new concreting operation. An exchange of the surface of the supporting body, which is formed by the forming means, can be caused by a change in the surface configuration of the concrete component to be produced therewith or in the wear of the forming means. The forming means can also represent, in whole or in part, a lost formwork, and therefore remain completely or partially in the concrete component after the vacuum has been switched off, whereas the supporting body can be reused.

The vacuum represents a temporary, at least for the duration of the concreting operation, environmentally friendly and environmentally stable fastener of the forming means to the formwork element. They can be attached to the same supporting body alone or in a plurality of different ways and can be configured the same or differently. If the forming means are configured planar and elastic, they can deform concavely when the vacuum is applied into the formwork element, so that they give a concrete component a convex surface in use.

Other than known systems, the formwork element according to the invention thus enables the use of very different forming means, both separately and in combination, without requiring any fundamental modifications to its structure. The formwork element thus offers a high degree of flexibility, which more than justifies its higher production expenditure and quickly amortizes through its versatile use.

However, a deformation of the forming means into the formwork element may also be undesirable. In order not to have to compensate for deformation in the case of larger formwork elements by a structural stiffness of the forming means, for example by material thickness, the formwork element can have a sufficiently or largely rigid, vacuum-permeable spacer according to an advantageous embodiment of the invention. It can be configured on the formwork element, attached to it or inserted separately. The spacer can provide a number of through passage openings which are closable under vacuum by a number of suctioned-on forming means. In a planar embodiment, the spacer can be positioned in the recess, that is to say between the rear wall and the upper side of the supporting body, spanning the recess or filling it up substantially or completely. It can be configured as a perforated plate, grid, air-permeable honeycomb plate or as a sufficiently stiff open-pore foam which is inserted into the recess. It can thereby provide or open a number of passage openings between the connecting devices for applying a vacuum on the one hand and the upper side on the other hand. In the case of a perforated plate, it can also comprise only one or a few or many passage openings, such as perforations or holes. In the case of a largely full-area arrangement of perforations, they can occupy up to 75% of the total area of the spacer or of the upper side without impairing the vacuum effect. In a linear or punctiform embodiment alternative to the planar embodiment, the spacer can have webs or spacing-holding pins which can project into the interior space from a rear wall of the formwork element opposite the upper side and can be fastened to the rear wall. Even with a linear or punctiform arrangement of a plurality of spacer holding means, passage openings can be produced which make possible a fluidic connection between the upper side on the one hand and the connecting devices on the other hand.

The passage openings can all be designed of the same type but can also have different shapes and sizes. They can be closed by a single or by a plurality of forming means. In this case, not all passage openings have to be closed, but in any case a majority of passage openings or the largest passage openings, in order to build up a vacuum and to maintain it. The spacer thus forms a positioning location or a support surface for the forming means. It allows a sufficient or defined distribution of the vacuum to the forming means. Depending on their type and nature, the passage openings can be dimensioned larger or smaller or arranged at distances closer or further apart from one another, or distributed evenly or unevenly.

According to a further advantageous embodiment of the invention, the formwork element can have a number of forming means, which are configured to adhere to the spacer by means of vacuum. Because they are held on the spacer by means of vacuum, they stick or hold there only for the duration of the existing vacuum. The vacuum thus holds the forming means in a predefined position without defining their own position. The almost full-surface effect of the vacuum in the formwork element allows a largely arbitrary arrangement of forming means in the region of the recess. After the vacuum has been switched off, the forming means can be released from the spacer without tools. The forming means may be a replaceable formwork shell or components of a lost formwork which remain on the concrete component or a combination of both. Components of the lost formwork, in the following, lost forming means, can include, for example, opposing formwork elements for electrotechnical mounting parts or boxes for receiving them, i.e., switches, sockets, light outlets, sensors or the like, but also objects for the refinement or functionalization of a concrete surface such as glass beads, spheres, mosaic stones or the like. For example, beads having a diameter of 2 to 200 mm have proven to be suitable lost forming means.

Alternatively, the forming means which do not act as a lost formwork may be one or more formliners for shaping the surface of a concrete component. Further alternatively, the effect of the forming means can go beyond a mere superficial structuring of the concrete component. It can form the design of the concrete component in a direction orthogonal to the concrete-contacted surface of the formwork element by a dimension which corresponds at most to the depth of the formwork element or the thickness of the concrete component. The concrete component can thus have, for example, a convex or concave curvature with a pass or a pitch of several centimeters, with a corresponding choice of the forming means. In the case of a convex curvature, the pitch can maximally reach the depth of the formwork element, or in the case of a concave curvature, the thickness of the concrete component and possibly lead to an opening. Instead of a curvature, the concrete component can receive angular elevations or depressions. The forming means can accordingly be configured three-dimensional and stiff. What is common to the forming means is that they influence the shape of the concrete component from the surface of the formwork element and thus from an outer side of the concrete component.

According to a further advantageous embodiment of the invention, the formwork element can comprise a partially perforated intermediate layer for mounting on the spacer. It can also be fastened by vacuum on the formwork element and can cover it completely or partially. The intermediate layer can be configured as a single-path or a multi-path element. It can be used as a template for the positioning of lost forming means, such as, in particular, opposing elements for electrotechnical installations. On the intermediate layer, the positions of the lost forming means can be identified and equipped with perforations with connection to the passage openings of the spacer for the reversible fastening of the lost forming means. The perforation of the intermediate layer is only in fluidic contact with those passage openings of the spacer which are required for the reversible fastening of the lost forming means, and “deactivates” the rest. The arrangement of lost forming means can thus be decoupled from that of the passage openings of the spacer and its shape and size. Both the intermediate layer and the lost forming means can thus be fastened to the formwork element by the vacuum, wherein the lost forming means adhere only in those regions of the intermediate layer in which the intermediate layer also has passage openings. In the region of the intermediate layer, the spacer therefore does not have any forced direct contact with the lost forming means.

According to a further advantageous embodiment of the invention, the formwork element can be equipped with a die as forming means. It forms a removable formwork shell with a structure that determines the concrete surface of the future component. Depending on the material of the die, it can be stiff or flexible. Their attachment by means of vacuum to the supporting body of the formwork element makes it possible to exchange them without great effort against a, for example, a differently structured or perforated die or another forming means. For its part, it can be at least partially perforated in order to be able to fasten an intermediate layer directly on it or template for lost forming means, such as opposing formwork elements or the like. Since the perforation of the die can then determine the position of the lost forming means, the spacer may have a different grid at passage openings, e.g., be configured as spot welding grids or sufficiently rigid foam. A spacer in a configuration as a rigid foam or as a grid may require the arrangement of a perforated die when and as far as its passage openings can not be closed by lost forming means. The arrangement of a separate die allows, in any case, a functional separation between the filling of the vacuum chamber for the planar distribution of the vacuum on the one hand and the positional definition of the lost forming means on the other hand. It can thus reduce the function of the spacer to the filling of the vacuum chamber for the planar distribution of the vacuum.

If the lost forming means are very small, such as, for example, the glass beads mentioned above, they can be transferred to the concrete by means of a perforated die or a so-called negative die. The perforated die spans the recess in the upper side of the formwork element so that the vacuum can directly work on it and the lost molding means to be implemented. These are thus held in position for a required duration of the concreting operation. This prevents both the unwanted displacement of the lost forming means by the concrete thrust during introduction of the fresh concrete and the sinking in of the lost forming means into the still liquid concrete matrix, in particular when the formwork is upright.

Negative die means that the die is precisely matched to the position and shape of the lost forming means to be implemented. When the vacuum is applied, the lost forming means seal the perforation of the mold air-tightly or gas-tightly, the lost forming means thus act as a closure or stopper so that no appreciable pressure losses occur. The die, in turn, opens directly on the spacer or in any case on the formwork element in a gas-tight manner. As a result of the vacuum and the gas-tight composite, the lost forming means adhere to the die. After the formwork element has been ventilated, and the vacuum is equivalently switched off, the lost forming means remain in the concrete due to the adhesion compound. The die can then be reused. Of course, only one such lost forming means can be processed.

For the implementation of glass beads, a configuration T-shaped in cross-section of the die recess or the opening receiving the bead in the die has been found to be advantageous. In this case, the upper diameter of the opening facing the concrete component corresponds to the diameter of the bead. The diameter of the lower part (which faces away from the component) of the die recess T-shaped in the cross-section is, on the other hand, about 50% smaller. The depth of the upper opening part is defined by the required binding depth of the bead into the concrete. This is generally 51 to 55% of the bead diameter. The depth of the lower die opening is 46 to 40% of the bead diameter. This ensures that the lower opening section is closed by the bead. The T-shaped configuration of the opening receiving the bead may alternatively also result from a larger perforation in the die and a smaller passage opening in an underlying spacer.

According to a further advantageous embodiment of the invention, the die and the spacer can be configured as one piece. Depending on the die design, a different density or stiffness of the spacer may be necessary, which is why different spacers can be assigned to different lost forming means. The spacer can also reinforce the die attached to it, which makes it easier to handle. The combination of the die and the spacer can, in turn, at least be partially perforated in order to be able to fasten an intermediate layer directly on it or template for lost forming means, such as opposing formwork elements or the like.

According to a further advantageous embodiment of the invention, the spacer and the supporting body can be designed as one piece. The formwork element can thereby be configured to be very compact and comprise few individual parts. Thus, the die remains as a replaceable component of the formwork element in order to allow a pattern change or a simple exchange of the die during wear.

According to a further advantageous embodiment of the invention, the formwork element can have a sealing strip running essentially around its circumference and facing the forming means on the supporting body and/or on the spacer. It can ensure a vacuum seal between the supporting body and a possibly not completely level forming means.

According to a further advantageous embodiment of the invention, the die or the above combination of the die and spacer can have a composite layer structure made of a rigid stability layer, an elastic sealing layer and a contact layer. The stability layer can be achieved by means of an aluminum composite plate, which offers high stiffness against torsion and bending, but simultaneously also low weight. It gives the die its structure. The elastic sealing layer can be achieved by a coating of the stability layer made of natural or synthetic rubber, EPDM, silicone, pourable silicon-based materials or the like and, besides its elasticity, provides a fluidic, in particular gas-tight, seal especially in the edge region of possible passage openings. Finally, the contact layer can consist of PET, PLA, PA or printing lacquer and determines the stripping behavior, the quality of the concrete surface and the protection of the underlying elastic sealing layer. It also allows a multiple use of the die and thus a higher number of casts or copies with the aid of the same die.

In addition to these and the known materials for the die, it is also possible according to the invention to use a composite material made of cellulose and polyethylene and aluminum films for them or the above combination of the die and spacers. Such dies can be produced industrially, can be easily processed, for example piercing, punching, gluing and cutting, and are therefore very cost-effective.

According to a further advantageous embodiment of the invention, the formwork element can have a supporting body with a planar, for example rectangular, possibly also oval or circular rear wall, with four rectilinear edges in the case of the rectangular supporting body, four edge strips for mounting on the edges, a vacuum-permeable spacer for mounting on the rear wall or at the edges between the edge strips and with connecting device for applying vacuum in one of the edge strips and/or in the rear wall.

The description of the previous formwork elements predominantly relates to such supporting bodies, which offered a largely level surface. According to a further advantageous embodiment of the invention, however, the formwork element can have a curved surface or at least two surfaces whose extension planes enclose an angle to each other. The principle according to the invention is thus not restricted to formwork elements which offer only a single surface located in an extension plane and thus influence a concrete component only from one of its shell surfaces. The principle according to the invention can also be realized with three-dimensional formwork elements, so that a design of concrete components is possible on several or all of its shell surface. In a simple embodiment, the formwork element may, for example, have a tubular shape with a square base surface and be used to create a concrete cube whose five shell surfaces can be shaped by the formwork element. The formwork element thus provides five surfaces which include a right angle with adjacent surfaces, respectively. A filling opening of the tubular shaped formwork element for concrete can be covered with a separate formwork element for shaping the sixth shell surface of the cube after filling the concrete. According to this principle, a plurality of concrete components can be produced, for example structure plates or plates with relief-like structured or patterned surfaces, round, angular or polygonal bodies such as supports, trusses or polygonal shaped walls, floors or ceilings, and other concrete shapes, of which several surfaces are to be designed in the same concreting process. In addition, the three-dimensional formwork element is not limited to at least two level surfaces, but may also have one or more curved surfaces, for example, a tubular shape with a circular base surface.

According to an advantageous embodiment according to the three-dimensional formwork element, instead of a spacer, it can have alternative spacer means, for example, webs or spacing-holding pins which project into the vacuum chamber from a rear wall of the formwork element opposite the upper side of the formwork element. Depending on the structure and geometry of the three-dimensional formwork element, separate planar spacers may not be applicable. The vacuum chamber which is nevertheless required can then be kept open via, for example, surface-stripping folds or via spacing pins which are attached so as to extend on the rear wall of the formwork element and into the vacuum chamber.

The object mentioned at the outset is also achieved by a formwork system for construction purposes with a number of formwork elements which can be coupled to one another for configuring a concrete formwork structure for site or ready-made concrete parts for receiving fresh concrete, with at least one formwork element according to one of the above claims. The formwork system can therefore comprise at least one or more formwork elements of the type described in more detail above, or consist completely of such formwork elements according to the invention. The formwork elements may be equipped with the same, for example regularly rectangular, ground plan, or with different, possibly recurring, ground plans which can be reversibly joined together to form an even surface or a spatial structure. The system can have the forming means described above, i.e., comprising at least one replaceable die and/or a combination of the die with a spacer, via an intermediate layer and/or forming means, which can be used as lost formwork.

The above-mentioned object is further achieved by a method for producing a ready-made concrete component with a formwork system according to the above claim, which comprises the following steps:
a) Creating a concrete formwork including at least one formwork element described in detail above, having a supporting body and forming means,
b) Applying a vacuum to at least one formwork element,
c) Positioning at least one forming means on the supporting body,
d) Introducing fresh concrete,
e) Setting of the concrete,
f) Stripping the concrete component.

The creation of a concrete formwork according to step a) is performed largely according to the state of the art. The incorporation of a formwork element according to the invention is, in principle, not yet a different procedure as it is adapted to the respective formwork system or to the coupling with it. However, differing from the prior art, in step b), a vacuum is applied to the formwork element according to the invention, which, in step c), enables the positioning of a forming means on the supporting body of the formwork element. With the application of the vacuum, at least one part or the entire formwork shell of the formwork element according to the invention can be produced.

Subsequently, in a conventional manner, fresh concrete is introduced into the concrete formwork, which can set in step e) until it is removed in step f) by stripping of the formwork system.

A vacuum is understood to be a decreased or reduced pressure or a gas pressure which is lower than the atmospheric pressure. In principle, the vacuum can be applied in different intensities and finally may lead to a vacuum in the ideal case. According to an advantageous embodiment of the method, a rough vacuum can be applied in step b) and an ultra-vacuum can be applied in step d). A reduced vacuum, which represents a clear reduction compared to the atmospheric pressure but still a considerable distance from a vacuum, can be regarded as a coarse vacuum. By contrast, a pressure state which represents a considerable reduction down to a vacuum is regarded as an ultra-vacuum. The intensities of the vacuum stages can be determined by an economical operation and by a handling of the forming means described in the following. During the application of the rough vacuum in step b), the formwork element according to the invention can be equipped with forming means and its position corrected. The rough vacuum thus allows a kind of attachment of the forming means to the supporting body, namely, possibly, a positional change or position correction of the forming means. If an ultra-vacuum is applied, this would no longer be possible. Ultra-vacuum, on the other hand, ensures the position of the forming means even under the influence of forces such as when the concrete is introduced. In particular, it provides sufficient resistance to the “concrete thrust” acting on the forming means. Whether a vacuum or, respectively, the intensity of the ultra-vacuum is required for this purpose can be determined by tests.

According to a further advantageous embodiment of the method according to the invention, in step e), a weak vacuum can be applied, or the vacuum generation can be switched off completely. The weak vacuum is to be selected in a range between the rough vacuum and the atmospheric pressure. After reducing the vacuum or switching off the vacuum generation, the vacuum escapes very slowly, partly over a period of several hours. This phase can therefore also be referred to as an “aeration phase”.

According to a further advantageous embodiment of the method according to the invention, the vacuum generation can be switched off when the green strength of the concrete is reached. At this point, the concrete has already reached a strength in which a change in the position of the forming means is no longer possible. Its adhesion to the formwork element according to the invention by means of vacuum is therefore no longer absolutely necessary.

In the case of flat concrete components which are produced horizontally, it is, of course, already possible to switch off the vacuum earlier, namely after the concrete has been introduced and compacted.

According to a further advantageous embodiment of the method according to the invention, in step b), a flat element having a partial perforation can be applied, so that the forming means can be fastened to the perforations in step c). The planar element or the intermediate layer can be a template, in particular for the correct positioning of opposing formwork elements for later electrotechnical installations or the like. This method step can also be used to geometrically modify the component to be concreted. In contrast to opposing formwork elements for electrotechnical components, as a rule, large-area opposing elements are fastened. During the rough vacuum, the positioning of the opposing formwork elements can be checked and, if necessary, corrected. As a result, later, very complex corrections to the concrete component can usually be avoided.

The object of the invention mentioned at the outset is also solved by the use of vacuum in the production of a concrete formwork structure for site or ready-made concrete components for the positioning of a forming means free of fastening and exactly located positioning of a forming means on an inner side of the formwork structure, which is contacts the concrete in use. The forming means can also be understood as a component which is to be embedded largely or completely in a concrete body.

The object mentioned at the outset is also achieved by concrete components which are produced by means of the formwork according to the invention or by the method according to the invention. This includes nearly arbitrarily shaped, essentially planar components, such as walls, ceiling or floor slabs or stairways, linearly acting components such as underlays or overlays, or point-acting components such as supports, but also predominantly decorative elements such as attachment or other building or component shells. What is common to them is that they have at least one component surface area designed and/or functionalized in the above-described manner, that is, in particular, a surface provided with structural components or designed through plastically protuberant structures or functional particles.

The principle of the invention is explained in more detail below by means of a drawing, by way of example. The drawings show:

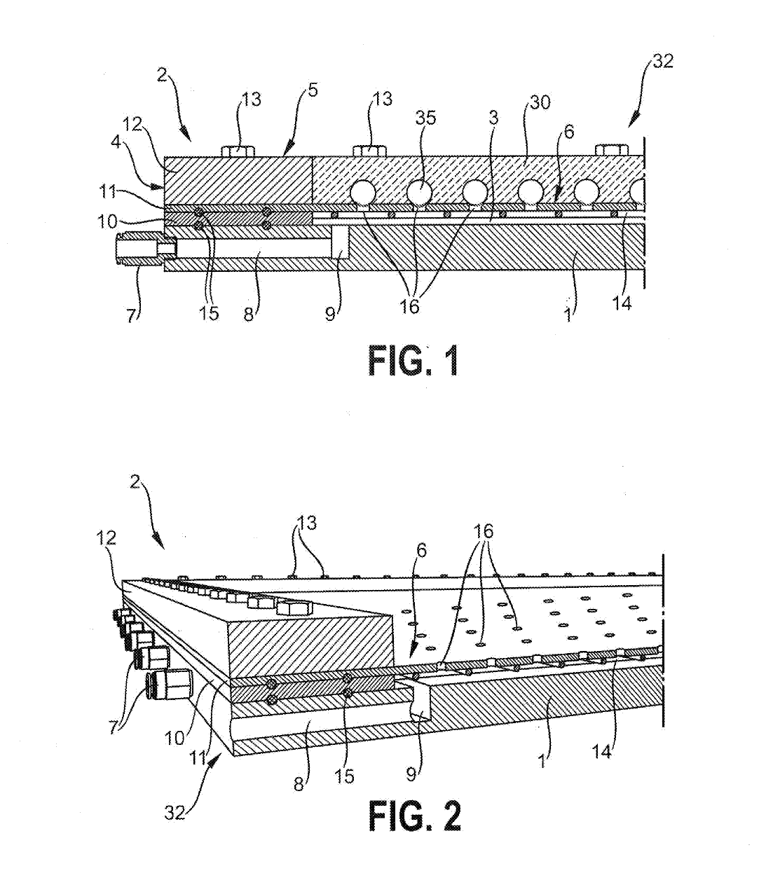

FIG. 1: A first formwork element according to the invention in a partial sectional view,

FIG. 2: Formwork element of FIG. 1 in a cut-away perspective view,

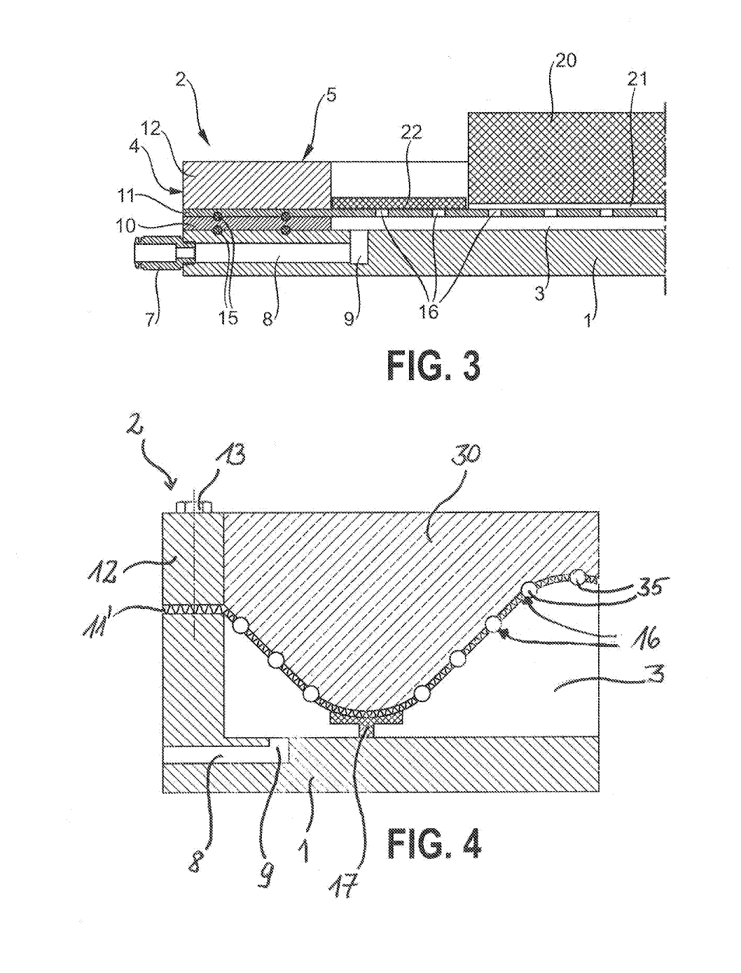

FIG. 3: A second formwork element according to the invention,

FIG. 4: A further formwork element according to the invention having a curved object holder,

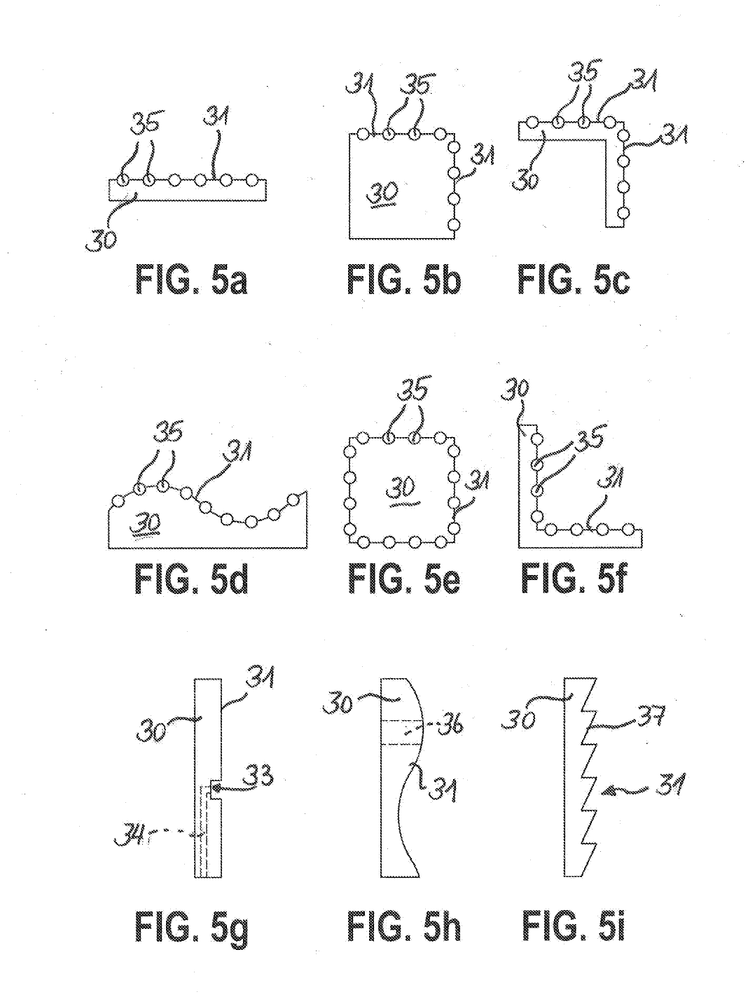

FIG. 5: A selection of concrete components which can be produced according to the invention,

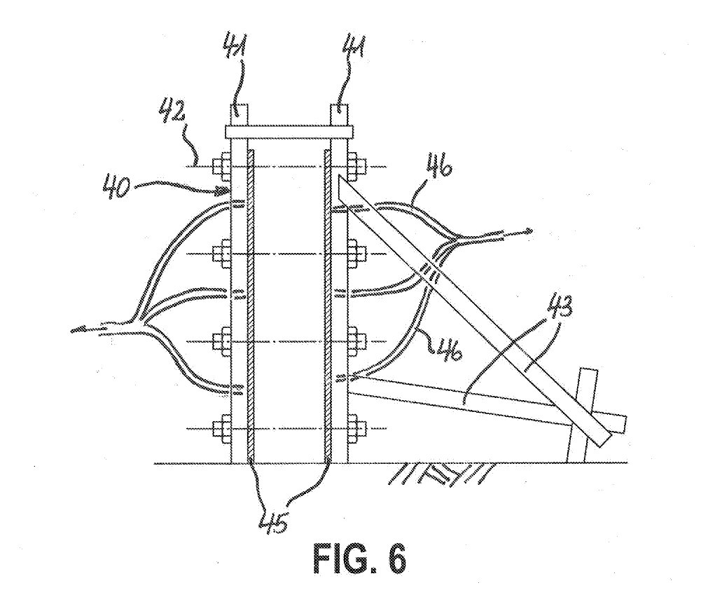

FIG. 6: A section through a system formwork.

FIGS. 1 and 2 show a formwork element 32 according to the invention for producing a concrete slab 30, one surface of which is provided with uniformly distributed glass beads 35 (only in FIG. 1). The formwork element 32 comprises a rectangular polymer base plate 1 as a component or rear wall of a supporting body of the formwork element 32. At the edge of the base plate 1 are affixed circumferential side edges 2, which together with the base plate 1 form a supporting body and enclose a largely cubic cavity 3. The side walls 2 have outwardly directed end faces 4 which run at right angles to the base plate 1. The side edges 2 each terminate with a surface 5, which are aligned parallel to the base plate 1. The surfaces 5 of the side walls 2 define an upper side 6 of the formwork element, which is divided by the cavity 3 as a recess of the formwork element and the upper sides 5 surrounding it. On the end faces 4, the formwork element has six connection devices or fluidic connections 7 which are each connected to a coaxial bore 8 in the plate plane of the base plate 1. Each bore 8 opens in a groove 9 running transversely to it. The groove 9 is milled from the direction of the upper side 6 into the base plate 1 and connects the adjacent bores 8 of the connections 7. With its open side, the groove 9 adjoins the cavity 3. There is thus a fluidic bond between the connection 7 and the cavity 3, which is used as a vacuum chamber after the application of negative pressure at the connections 7, via the connection 7, the bore 8 and the groove 9.

The side walls 2 run at the four edges of the rectangular base plate 1 and each composed of, in the direction orthogonal to the base plate 1, a strip-shaped and approximately 6 mm thick grating holder 10 made of PVC, a plate-shaped object support 11 supported thereon, and a strip-shaped clamping strip 12 approximately 21 mm thick. The object support 11, as a plate-shaped die, is a formwork shell of the formwork element 32 and is made of PVC with laminated EPDM. The clamping strips 12 are screwed into the base plate 1 by means of a plurality of M8×40 hexagonal screws. They clamp both the grating holder 10 and the object support 11 between them. While the grating holder 10 has largely the same width and length dimensions as the clamping strip 12, the object support 11 extends essentially over the same surface as the base plate 1. It thus projects into the cavity 3. Parallel to this, a spot welding grid 14 having a mesh width of 25×25 mm is fastened in the grating holder 10. It extends between the base plate 1 and the object support 11 over the entire surface of the base plate 1, is exposed in the region of the cavity 3, and supports the object support 11 on the lower side. It is thus used as a spacer between the object holder 11 on the one hand and the base plate 1 on the other hand, which maintains the cavity 3. It prevents a possible bulging of the object support 11 as a result of the vacuum which occurs later by the evacuation. Four round cords 15 with a diameter of 4 mm each seal in pairs the grating holder 10 opposite the object support 11 on the one hand and the base plate 1 on the other hand.

The additive construction of the formwork element enables, on the one hand, the modular joining of several individual elements to enlarge formwork elements, and on the other hand, to exchange individual components. The possibility of exchanging the object support 11 is of particular advantage. Depending on the application, it can be optimized with regard to the number of recesses, its cross-section or its material properties.

Depending on the design desire of the concrete slab 30 to be produced, the object support 11 is thus designed or provided with openings. In the present case, the object support 11 has, as a rigid piercing die, regularly arranged through holes 16 with a diameter of 6 mm, which lead into the cavity 3 as a spacer through the spot welding grid 14. The object support 11 is used to be coated with the glass beads 35, which are cast into the surface of the concrete slab 30.

Through the embedding of the glass beads 35 in the manner shown, each bead 35 also receives particular reflection properties. Incident radiation is reflected largely independently of the orientation of the bead 35 mostly in the direction back to the radiation source. This reflection behavior arises due to the embedding, i.e., without additional modifications of the bead 35. The reflection behavior of the beads 35 embedded in the concrete surface is the one retroreflector.

The production of the concrete slab 30 takes place by first coating the object support 11 with glass beads 35. As soon as the object support 11 is completely coated and each of its through holes 16 is closed by means of a glass bead 35, vacuum is applied to the connections 7. The EPDM lamination on the object support 11 ensures reliable sealing of the through holes 16 by the beads 35. The vacuum reduces or evacuates the pressure in the cavity 3, the groove 9 and the bore 8. As a result, the glass beads 35 are sucked on and held on the object support 11 in a captive manner or immovably. Now the formwork element 32 may even be erected and possibly integrated into a conventional system formwork. The vacuum is sufficiently strong that the glass beads 35 are also held in a vertical position of the formwork element 32, but they can resist a concrete thrust in any case during the introduction of the concrete.

The vacuum generation can be reduced and finally switched off while the concrete is setting. That is because with increasing hardening of the concrete, the glass beads 35 are held by it and no longer need any adhesion to the object support 11. After the concrete has set, the formwork can finally be removed and with it the formwork element 32. The glass beads 35 detach easily from the object support 11 at the same time. They are now permanently incorporated and fastened in the concrete slab 30.

The object support 11 according to FIG. 1, just like the glass beads 35, is a forming means for the concrete slab 30 to be produced. In addition, the glass beads 35 themselves form a type of lost formwork or lost forming means because they remain in the concrete slab 30 after completion of the concreting operation. Moreover, they also cause a functionalization of the concrete component because they together form a reflector on the concrete surface in the above manner. According to the same principle, opposing formwork elements for electrotechnical installations can also be positioned on the formwork element 32 according to the invention and installed in a concrete component:

FIG. 3 shows a section comparable to FIG. 1, wherein, in contrast, glass beads 35 are not applied to the object support 11, but rather an opposing formwork element 20. It covers a plurality of through holes 16 of the object support 11 and rests with a rubber seal 21 on the object support 11 so that it is reliably sucked through the through holes 16 of the object support 11 on it. The remaining through holes 16 which are not covered by the opposing formwork element 20, conceal a wooden support 22 so that all the through holes 16 of the object support 11 are closed. During the subsequent concreting process, which in principle takes place in the same way as already mentioned above, the formwork element 32 according to the invention holds the opposing formwork element 20 in the correct position during the concreting. After switching off the vacuum generation, the opposing formwork element 20 and the wooden support 22 can be easily released from the object support 11 of the formwork element 32 without using tools. This can then be re-used for a further concreting operation without any significant cleaning or other post-processing operations.

The formwork element according to the invention can also be used without the use of functional elements for the design of a surface of a concrete component. FIG. 5h shows a concrete component 30 with a curved surface 31, from which a passage 36 completely penetrates the concrete component 30. It can be produced with a formwork element according to FIG. 4, using a closed, flat and corrugated object holder, which carries an opposing formwork element 20 according to the principle shown in FIG. 3 for the configuration of the passage 36.

FIG. 4 shows a partial section through a further example of a formwork element according to the invention. In principle, similar to those of FIGS. 1 to 3, it is composed of a base plate 1 having a vacuum connection comprising the bores 8 and the groove 9. However, its side walls 2 protrude further and, by means of the clamping strip 12 and the hexagonal screw 13, clamp a three-dimensionally shaped die as an object support 11′, which has a plurality of through holes 16. In them, glass beads 35, which occupy the future surface of a concrete component 30 as functional particles, are predominantly on the concrete side.

A spacer 17 is inserted at those locations at which the object support 11′ approaches the base plate 1 and a risk therefore exists that the object support 11′ is pressed onto the base plate 1 under the influence of the weight of the fresh concrete. It is already formed on the object support 11′ and is supported on the base plate 1. Thus, the spacer 17 ensures that the cavity 3 remains open between the object holder 11′ and the base plate 1 and is not interrupted by the contact of the object holder 11′ on the base plate 1. Otherwise, the vacuum could possibly not spread uniformly on the underside, which faces away from the concrete, of the object support 11′ in the formwork element and does not hold the glass beads 35 in the desired position during the concreting process.

FIGS. 5a to 5i show a selection of possible forms of surfaces 31, 37 or concrete components 30 designed according to the invention: FIG. 5a schematically shows a plate-shaped concrete component 30 whose one surface 31 is occupied by glass beads 35. The glass beads 35 are permanently incorporated and fastened into the concrete component 30 and are used as reflectors of incident light. Thus, they not only shape the surface 31, but also functionalize it, by giving it a reflective function. Their reflective function is thus much more durable than that of reflective paints.

FIG. 5d also shows a flat concrete component 30 whose one surface 31 is not even but rather corrugated in section and is also occupied by glass beads 35. Thus, the reflecting effect of the surface 31 can be extended to a larger angular range. The production of the concrete component 30 of FIG. 5d with a formwork element according to the invention is shown schematically in FIG. 4.

FIGS. 5b and 5e show a cross-section through a square concrete component, the extension of which can be arbitrarily large, orthogonal to the drawing plane. The concrete components 30 can accordingly be, for example, a support or a stair step, according to FIG. 5b also a support beam. The concrete components 30 according to FIGS. 5b and 5e can be produced by formwork elements according to FIGS. 1 to 3, wherein they can be produced in any case with vertically standing functionalized surfaces 31, the component 30 according to FIG. 5b possibly also horizontal. That is because the formwork element according to the invention makes it possible to also hold the glass beads 35 on a vertical surface before and during the concreting operation.

The concrete components 30 shown in section according to FIGS. 5c and 5f can be, for example, stair steps, moldings for a façade or support linings. They enable existing components to be retrofitted with a functionalized surface 31, in the present case with coated with glass beads. Its production effort is consequently less than that of a complete support or stair step with the desired functionalized surface. Together with a concrete component 30 according to FIG. 5a, it is also possible to functionalize large or strongly profiled surfaces, in which they are coated by concrete components 30 according to FIGS. 5a, 5c, and 5f (and, if appropriate, further, for example, convex or concave curve-shaped finished parts).

FIG. 5g shows a concrete component 30 with an inlet niche 33 and an empty pipe 34 connected thereto and concreted. The inlet niche 33 can be produced in a formwork element according to the method described in FIG. 3 for positioning an opposing formwork element 20 on the object carrier 11 (see FIG. 3).

Finally, FIG. 5i shows a concrete component 30 having a surface 31 which is shaped as a saw-tooth or shed-roof shape and carries several identically shaped riders 37. In principle, vacuum formworks according to the invention are not absolutely necessary, but are useful, for this and for the concrete component 30 according to FIG. 5h. Because the advantage of their use in the production of concrete components 30 according to FIGS. 5g to 5i lies in their flexibility, in their simple equipping with opposing formwork elements for the configuration of the recess 33, of the passage 36 (FIG. 5g) or the uniform or even non-uniform shape of the rider 37 according to FIG. 5i and its problem-free multiple usability. When flexible dies are used as object holders 11 or 11′ (see FIGS. 1, 3 and 4), their two- or three-dimensional shapes can also be simply altered and thus also be flexibly used for a large number of different concrete moldings.

FIG. 6 illustrates the use of the formwork element according to the invention within a conventional system formwork 40: between two vertically projecting formwork walls 41, which are supported by means of conventional anchors 42 at a uniform distance from each other and via push-pull props 43 like a positional securing on a subgrade, formwork elements 45 according to the invention are attached to the concrete-facing inner sides of the formwork walls 41. They are connected to a vacuum generating device via vacuum lines 46 through the conventional formwork shell of the formwork walls 41. The anchors 42 clamp down the formwork elements 45 and are therefore sealed pressure-tight with an anchor passage in the form of a rubber seal or a fluid-tight sleeve. After assembly of the formwork elements 45 of the system shell 40 and the application of vacuum via the vacuum lines 46, the concrete can be introduced into the system shell 40 in a conventional manner and compressed. Even before reaching its green strength, the vacuum generation can be switched off and the concrete can continue to harden. The concrete wall to be created can then be conventionally switched off. The formwork elements 45 can be used for a further use after a cleaning.

Since the preceding formwork elements described in detail are exemplary embodiments, they can be modified in a conventional manner by a person skilled in the art without departing from the scope of the invention. In particular, the concrete embodiments of the object holders can also follow a different form from the one described here. Likewise, the spacer can be designed in a different form if this is necessary for space or design reasons. Furthermore, the use of the indefinite articles “a” or “an” does not exclude the fact that the relevant features can also be present several times or more.

### LIST OF REFERENCE NUMBERS

1 Base plate
2 Side walls
3 Cavity
4 Front side
5 Surface
6 Upper side
7 Connection
8 Bore
9 Groove
10 Grating holder
11, 11′ Object support
12 Clamping bar
13 Hexagon screw
14 Spot welding mesh
15 Round cord
16 Through holes
17 Spacer
20 Opposing formwork element
21 Rubber seal
22 Wooden support
30 Concrete component
31 Surface
32 Formwork element
33 Niche
34 Empty pipe
35 Glass bead
36 Passage
37 Rider
40 System formwork
41 Formwork wall
42 Anchor
43 Push-pull prop
45 Formwork element
46 Vacuum line

1. Formwork element (32) for a formwork system for concrete building purposes, in particular for integration into a construction plane of the formwork system,
having a box-like concrete supporting body (1, 2) facing away from the concrete,
having an upper side (6) facing towards the concrete in use,
with a recess (3) in the upper side (6) for fastening concrete-facing forming means (11; 11′; 35) which can be attached to/in the recess (3),
having a vacuum-permeable spacer (14; 17) having a plurality of passage openings (16) and
having connection devices (7, 8, 9) for applying a vacuum,
so that a plurality of forming means (35) can be reversibly fastened on the upper side (6) by means of vacuum.

2. Formwork element according to the preceding claim, characterized by passage openings (16) which can be closed by the forming means (35) suctioned under vacuum.

3. Formwork element according to the preceding claim, characterized by a plurality of lost forming means (35) which are configured to adhere to the spacer by vacuum and to remain in the concrete.

4. Formwork element according to one of the preceding claims, characterized by a partially perforated intermediate layer (22) for mounting on the spacer or a die (11).

5. Formwork element according to one of the preceding claims, characterized by a die (11′) having a structure which determines the concrete surface of the future concrete component as a forming means.

6. Formwork element according to one of the preceding claims, characterized by a perforated die (11′) which spans the recess and can be closed by lost forming means (35).

7. Formwork element according to the preceding claim, characterized by a one-piece configuration of the die and of the spacer.

8. Formwork element according to the preceding claim, characterized in that the die comprises a composite layer structure of a rigid stability layer, an elastic sealing layer and a contact layer.

9. Formwork element according to one of the preceding claims, having a three-dimensionally extending upper side.

10. Formwork system for concrete building purposes having a number of formwork elements for configuring a concrete formwork structure for receiving fresh concrete, with at least one formwork element according to one of the above claims.

11. Method for producing a concrete component having a formwork system according to claim 7, having the following steps:
a) Creating a concrete formwork including at least one formwork element according to one of claims 1 to 6,
b) Applying a vacuum to the formwork element,
c) Positioning a forming means on the supporting body,
d) Introducing fresh concrete,
e) Setting the concrete,
f) Stripping the concrete component.

12. Method according to the above method claim, wherein the vacuum is switched off when the green strength of the concrete is reached.

13. Use of vacuum in the creation of a concrete formwork structure for the positioning of a forming means on the concrete-contacting inner side of the formwork, the positioning being free of fastening means and exactly located.

14. Concrete component having a designed surface, which is produced by means of a formwork element according to one of claims 1 to 7 or by a method according to claim 8.
